(19) United States
(12) Patent Application Publication
(10) Pub. No.: US 2014/0337126 A1
(43) Pub. Date: Nov. 13, 2014

(54) TIMED COMMENTS FOR MEDIA

(71) Applicant: Viki, Inc., San Francisco, CA (US)

(72) Inventors: Nerses Ohanyan, San Francisco, CA (US); David Baldeshwieler, San Francisco, CA (US)

(73) Assignee: Viki, Inc., San Francisco, CA (US)

(21) Appl. No.: 14/272,989

(22) Filed: May 8, 2014

Related U.S. Application Data
(60) Provisional application No. 61/820,896, filed on May 8, 2013.

(51) Int. Cl. G06Q 30/02

(52) U.S. Cl. CPC G06Q 30/0251
USPC 705/14.49

(57) ABSTRACT

A method for performing an action in association with media, the media including audio and video, the method including streaming a first media to a first user device; receiving a set of comments for the first media from the first user device, each comment associated with a timecode of the first media; extracting a comment parameter from the set of comments; selecting an advertisement based on the comment parameter; streaming the first media and the set of comments to a second user device in response to receipt of a request for the first media; and facilitating advertisement presentation on the second user device in association with the first media.

### CROSS-REFERENCE TO RELATED APPLICATIONS

This application claims the benefit of U.S. Provisional Application No. 61/820,896 filed 8-May-2013, which is incorporated in its entirety by this reference.

### TECHNICAL FIELD

This invention relates generally to the media field, and more specifically to a new and useful system and method of facilitating and leveraging timed comments in the media field.

### BRIEF DESCRIPTION OF THE FIGURES

FIG. 1 is a schematic representation of the method of facilitating timed commenting on media.

FIG. 2 is a schematic representation of a variation of the method, including a first and second commenter account and a viewer account.

FIG. 3 is a schematic representation of media including timecoded comments over the media timeline.

FIG. 4 is a representation of facilitating user commenting in association with a media duration.

FIG. 5 is a schematic representation of an example of determining comment parameter values for the media, for a subset of comments satisfying a condition.

FIG. 6 is a schematic representation of an example of determining media parameter values for the media duration associated with a comment associated with the media.

FIG. 7 is a schematic representation of an example of determining media parameter values for a given media duration.

FIG. 8 is a schematic representation of an example of generating the audience profile for a piece of media based on the second media durations, identified based on the respective comment parameter values.

FIG. 9 is a schematic representation of an example of generating a first audience profile for a first user for a first media based on user interactions with the comments associated with the first media, and generating a second audience profile for a second user for the first media based on the comments associated with the first media.

FIGS. 10 to 13 are schematic representations of advertisement presentation variations.

FIG. 14 is a schematic representation of an example of identifying an audience for an advertisement based on the comments associated with media.

FIG. 15 is a schematic representation of an example of generating secondary media comprising highlights of the first media.

FIG. 16 is a schematic representation of an example of facilitating user discovery of media through secondary user comments.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

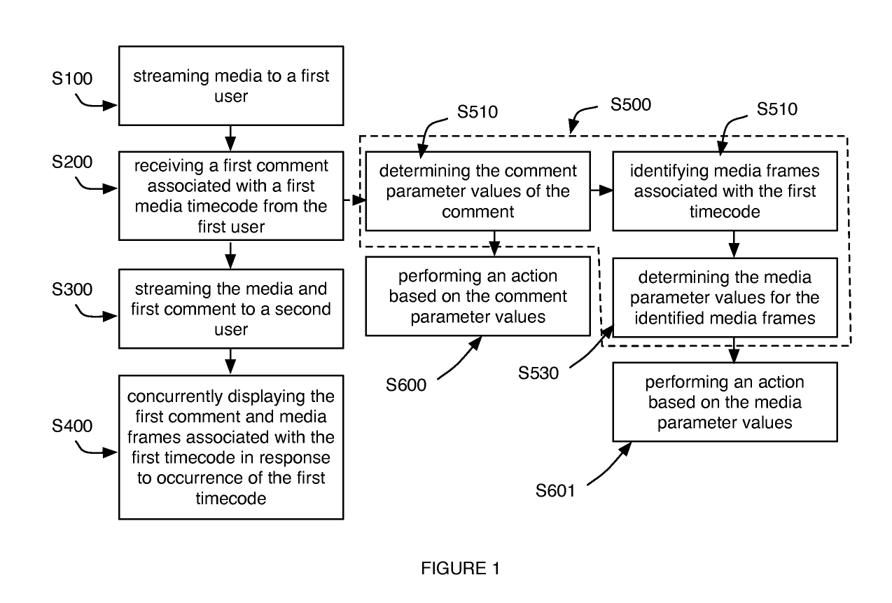

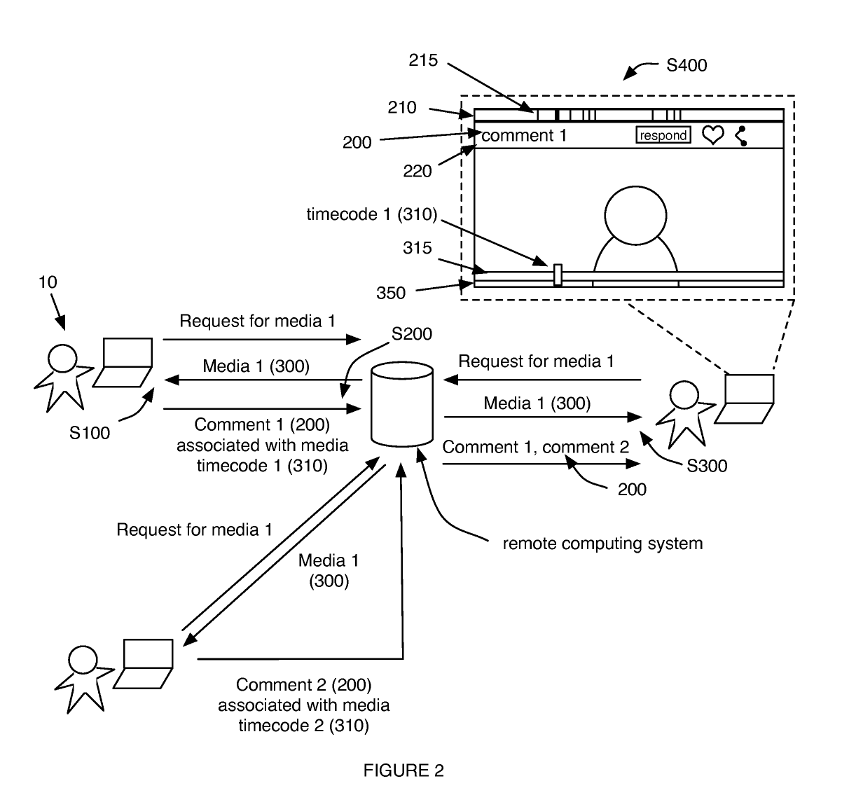

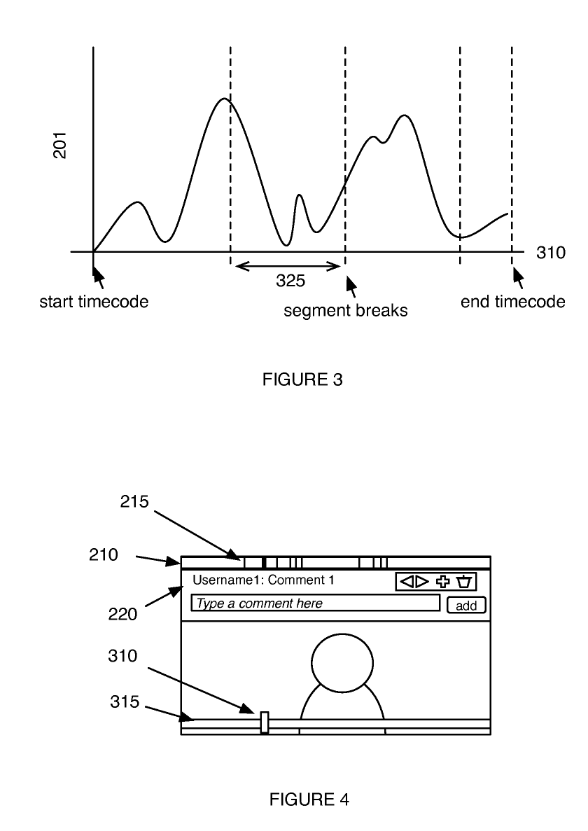

As shown in FIGS. 1 and 2, the method of facilitating timed commenting on media includes streaming the media to a first user S100; receiving a comment in association with a timecode of the media from the first user S200; and streaming the media and the comment to a second user S300, wherein the comment is rendered concurrently with the media at the timecode S400. The method functions to facilitate user media commenting on a per-scene or per-frame basis. The method can additionally function to indicate the comment association with the scene or frame to other users by displaying the comments in association with the scene or frame. The method can additionally function to facilitate comment and media analysis to identify the most popular portions of a piece of media, the most popular subjects of the media, the most common associations with the media, or any other suitable parameter. The identified media or comment parameters can be subsequently used to select advertisements for the media, to select recommended media for a user, to generate secondary media (e.g., other audio-video files, GIFs, etc.), to add or edit subtitles associated with the media, or used in any other suitable manner.

This method can confer several benefits over conventional methods. First, by overlaying or otherwise presenting the comments in-synchronization with the media, users are given additional context about the comment. Second, media providers and advertisers can easily identify which scenes, subjects, or other media parameters resonate with the user audience, and tailor advertisements and secondary media to those scenes. The media providers can additionally use the comment parameters (e.g., comment density) to identify media highlights, segment the media, or process the media in any other suitable manner. The method can additionally reduce costs for advertisement analyses by reducing the number of data sources to be analyzed.

The method is preferably performed by a system 100 including a plurality of networked computing systems (e.g., processing units), but can alternatively include a single computing system. The system preferably includes a media management module that functions to receive media play requests from remote user devices and send (e.g., stream) media to the remote user device. The system can additionally include a subtitle management module that functions to receive subtitles from a user device for media (e.g., colocalized or remote), store the subtitles in association with the media, and send (e.g., stream) the subtitles in association with the media to the remote user device in response to receipt of a request for subtitles from the remote user device. The system can additionally include a comment management system that functions to receive comments 200, each associated with a media timecode 310, for a piece of media from a remote user device, store the comment in association with the media, and send (e.g., stream) the comment to a second remote user device in response to a request for comments or the media from the second remote user device. The system can additionally include a comment analysis module that functions to analyze and extract comment parameters from the comments for a piece of media. Comment parameters 201 can include the comment density, comment frequency (e.g., over global time or as a function of the media timeline, comment rate (e.g., over global time or as a function of the media timeline), comment sentiment, comment novelty (e.g., how recently was the comment posted), commenter parameters (e.g., the demographic, age, profile, location, etc. of the commenter), or any other suitable comment parameter. Comment parameters can be determined for the media as a whole, each media segment 325, scene, clip, frame 326, or any other suitable media duration 320. The comment analysis module can additionally include a timecode extraction sub-module that functions to determine the timecode associated with each set of comments (e.g., single comment or plurality of comments). Each identified timecode is preferably associated with a set of comments that satisfies a selection condition, such as a set of comments having a comment parameter value beyond a threshold value. However, the selection condition can be any other suitable condition, and the identified timecode can be any other suitable timecode. The system can additionally include a media analysis module that functions to analyze and extract media parameters 301 from media durations based on the timecodes extracted by the comment analysis module. The media analysis module preferably identifies the media scene, segment, frame, or any other suitable media duration associated with the timecode (e.g., that the timecode is assigned to, that encapsulates the frame associated with the timecode, that is a predetermined number of frames or timecode units away from the identified timecode, etc.) and analyzes the identified media duration to extract the media parameters. The media parameters can be automatically extracted or manually extracted. The media parameters can be extracted from metadata associated with the media (e.g., with the media as a whole, with the media frame, with the media scene, etc.), or can be determined using automated processing methods (e.g., machine learning methods, image analysis methods, audio fingerprinting methods, etc.). The media parameters can include video parameters, audio parameters, or any other suitable parameters of the media. The video parameters can include a subject of the media duration (e.g., identify the actor, identify the furniture, identify the jewelry, etc.), the color tones of the media duration, the background of the media duration (e.g., the setting), or any other suitable video parameter of the media. The audio parameters can include the voice actor, song artist, song genre, bandwidth, BPM, tenor, average spectrum, spectral flatness, prominent tones, average zero crossing rate, or any other suitable audio parameter of the audio file of the media duration.

The media used with the system and method can include a video file and/or an audio file. The media can additionally include associated metadata. The media is preferably coded with a set of timecodes, which can be used to synchronize audio frames of the audio file with video frames of the video file. The timecodes are preferably independent of global timestamps (e.g., ISO 8601 standard timestamps), but can alternatively be dependent upon or be a global timestamp. The media is preferably streamed to a remote user device, but can alternatively be downloaded by the remote user device or otherwise sent to the remote user device. The media can be pre-divided or dynamically divided into one or more media durations. The media durations can be a media segment or scene, which preferably includes a subset of the media associated with a plurality of timecodes (e.g., less than the entirety of the media length but alternatively the entirety of the media length); a clip, which preferably includes a subset of the segment or scene associated with a timeframe subset of the set of scene timecodes; a frame, which is preferably associated with a single timecode; or any other suitable media unit associated with any suitable number of media timecodes. The media is preferably played by a media player on the remote user device, but can alternatively be played on any other suitable system. The media player can be a native application on the user device, a browser-supported media player, or any other suitable media player.

Streaming the media to a first user S100 functions to present the media to a first user. The media 300 is preferably streamed to a user 10, more preferably a user device, but can alternatively be streamed to a user account or any other suitable user representation. The media is preferably streamed to the first user, but can alternatively be downloaded or otherwise sent. The media is preferably streamed from the remote computing system, but can alternatively be streamed from a third party or second remote computing system. The media is preferably sent in response to receipt of a request from the first user device, but can alternatively be sent in response to any other suitable event. Streaming the media preferably includes sending a timecoded audio file or portion thereof to the first user and sending a timecoded video file or portion thereof to the first user. Streaming the media can additionally include streaming subtitles associated with the media portion to the first user. Streaming the media can additionally include streaming comments, more preferably timecoded comments, associated with the media portion to the first user. Streaming the media to the first user can additionally include playing the media portion at the first user device. The media is preferably played by a media player 350, but can alternatively be played in any other suitable manner.

Receiving a set of comments in association with a media timecode S200 functions to receive a timecoded comment. The timecoded comment is preferably received from the device rendering the media, but can alternatively be received from a secondary device. The comment can be received in the comment window, as shown in FIG. 4, or can be received at any other suitable location. The timecoded comment is preferably displayed in real time to the commenting user (commenter) and/or secondary users (e.g., secondary user accounts or devices), receiving the media, at the timecode associated with the comment. Alternatively, the timecoded comment can be displayed to subsequent viewers of the media segment only. The set of comments can include a single comment or a plurality of comments. Each comment of the set is preferably associated with a timecode of the media. The timecode of each of the comments can be different timecodes or the same timecode. The comment is preferably received from a user device in association with a user account, but can alternatively be unassociated with a user account. The comment can be text, audio, image, video, or be any other suitable media type. The comment is preferably associated with a media timecode, but can alternatively be associated with any other suitable time-based identifier for the media. The comment can alternatively or additionally be associated with metadata, such as a global timestamp (e.g., recording the time at which the comment was entered or received), a geographic location (e.g., recording the location from which the comment was received), a device type or identifier, or any other suitable data. The information, including the comment content, comment timecode, and/or metadata, can subsequently be used to select the advertisement and/or select the advertisement presentation method.

The timecoded comment can be received from a single user or multiple users for a given piece of media. For example, the method can include streaming the media to a first user, receiving a comment from the first user in association with a first timecode, streaming the media to a second user, receiving a second comment from the second user in association with a second timecode, and streaming the media to a third user, including the first and second comments, wherein the first and second comments are preferably displayed at the first and second timecodes, respectively.

Receiving the timecoded comment can additionally include assigning a timecode to the comment. Assigning a timecode to the comment can include receiving a comment at a paused timecode (e.g., wherein media playback is paused at the paused timecode), wherein the paused timecode is assigned to the comment. Assigning a timecode to the comment can alternatively or additionally include assigning the media timecode at which the comment entry selection was received (e.g., the timecode of the media frame that was playing when the “comment” icon was selected) to the comment. Assigning a timecode to the comment can alternatively or additionally include assigning the media timecode at which the comment was received to the comment. Assigning a timecode to the comment can alternatively or additionally include assigning a user-selected media timecode to the comment, wherein the user can select the media timecode before or after comment entry. The user can select the timecode at a media timeline 315 concurrently displayed with the media, at a comment timeline 210 concurrently displayed with the media (e.g., displayed over the media), enter the timecode, or otherwise select the timecode to be associated with the comment.

The comment is preferably associated with the timecode at the user device of the commenter, but can alternatively be associated with the timecode at the remote computing system or associated with the timecode by any other suitable system. The comment is preferably received in an overlay over the media (e.g., within the media player), but can alternatively be received in a window adjacent the media (e.g., outside the media player), received on a second device in association with the media, or received at any other suitable location.

In response to comment receipt at the user device, the comment is preferably sent to the remote computing system, received by the remote computing system, and stored by the remote computing system is association with the media. The comment is preferably stored in a comment list separate from and associated with the media, but can alternatively be embedded into the media or associated with the media in any other suitable manner.

Streaming the media and the comment to a second user S300 functions to display the comment received from the first user to the second user. The media is preferably streamed to a second user device, but can alternatively be streamed to a second user account or any other suitable user representation. The media is preferably streamed to the second user, but can alternatively be downloaded or otherwise sent. The media is preferably streamed from the remote computing system, but can alternatively be streamed from a third party or second remote computing system. The media is preferably sent in response to receipt of a request from the second user device, but can alternatively be sent in response to any other suitable event. The comment, more preferably the comment list associated with the media, is preferably streamed to the second user in association with the media. The comment can be concurrently sent with the media, sent serially with the media, or sent in any other suitable order relative to the media. The comment is preferably sent in real time as the comments are received at the system, but can alternatively be sent asynchronously or at any other suitable time. In one example, a comment is received for a first media timecode at a first time from a first user account or user device. Media previously sent to a second user device is preferably updated with the comment, such that the comment is displayed when media playback at the second user device reaches the first media timecode. Alternatively, the media previously sent to the second user can remain un-updated with the new comment, wherein only comments received by the system prior to media streaming to the second user device will be presented at the second user device. However, the comments can be rendered in any other suitable order.

The comment is preferably rendered concurrently with the media upon occurrence of the timecode during media play S400. For example, the comment associated with a first timecode can be presented concurrently with an audio and/or video frame encoded with the timecode. The comment can be displayed concurrently with the media frames associated with the comment timecodes (e.g., wherein the comment is associated with a set of contiguous or separated timecodes). Alternatively or additionally, the comment can be displayed for a predetermined period of time relative to the timecode associated with the comment (e.g., a predetermined period of time before and/or after the timecode). For example, the comment can be displayed for 10 seconds of media play, starting at the timecode. Alternatively, the comment display time period can be determined based on the comment length or file size. For example, a first comment having a first length can be displayed for a longer period of media play than a second comment having a second length shorter than the first length. Alternatively or additionally, the comment can be presented until the timecode of the next comment associated with the media. However, the comment can be presented during playback or presentation of any other suitable portion of the media.

The comment is preferably rendered as an overlay over the media, within the media player. The comment is preferably rendered along an edge of the media player within a window 220, more preferably along the top of the media player, but can alternatively be rendered along any other suitable portion of the media player. Alternatively, the comment can be rendered in a window adjacent the media player. In one example, the comment can be rendered as part of a timecode-ordered comment list, wherein the comment list scrolls to substantially center the comment associated with the instantaneous timecode within the comment list window. The comment is preferably displayed in a comment box, but can be displayed in any other suitable manner. The comment box is preferably fixed-height, but can alternatively have a height that adjusts according to the number of comments associated with the timecode. The comment is preferably displayed in association with (e.g., adjacent) a representation of the commenter account, such as an icon, image, name, or any other suitable representation of the commenter account. The representation of the commenter account can function as a link to the commenter account. The comment can additionally or alternatively be displayed in association with a respond icon, wherein a second comment can be received in response to selection of the respond icon. The second comment is preferably a response to the first comment, and can be associated with the first comment. Alternatively, the second comment can be unassociated from the first comment. The second comment is preferably associated with a timecode and the media. The timecode associated with the second comment can be the timecode of the first comment, a second timecode after the timecode of the first comment (e.g., a predetermined duration after the first timecode), the timecode of second comment receipt, the timecode of respond icon selection, or any other suitable timecode. The comment can additionally be rendered in association with an on/off icon, wherein selection of the on/off icon switches comment display between a displayed mode and a hidden mode.

The comment is preferably rendered in association with a comment timeline. The comment timeline preferably visually represents all the comments associated with the media, across all media timecodes for the media. A comment marker 215 is preferably displayed in the comment timeline for each comment or set of comments associated with the media, but the comments can be otherwise represented. The comment timeline can additionally function as media and/or comment list navigation. In response to selection of a first comment marker representative of a first comment, the first comment and the media frames associated with the timecode of the first comment are preferably displayed. Media playback can be initiated from the timecode of the first comment, or media playback can be paused at the timecode of the first comment.

When multiple comments are associated with the same timecode or multiple timecodes having close proximity (e.g., wherein the difference between the timecodes falls below a threshold duration), the comments can be aggregated into a comment list. The media duration that the comment list is concurrently shown with is preferably determined based on the timecodes associated with the comments in the comment list. The media duration preferably encompasses the timecodes associated with the comments in the comment list, but can alternatively be shorter or longer. The length of the media duration is preferably determined based on the number of comments in the comment list, but can alternatively be determined based on the length of the comments in the comment list, or selected in any other suitable manner. Alternatively, when the comments are all associated with a single timecode, the comments can be individually serially shown in chronological order (e.g., according to the order of comment receipt) serially shown in reverse chronological order (e.g., according to the order of comment receipt), serially shown according to relevancy to the viewing user (e.g., based on the association of the commenter with the user, the comment content with the user interests, etc.), or rendered in any other suitable order. The presentation duration of each comment can be predetermined, determined based on the number of comments associated with the timecode, or otherwise determined. When the comments are associated with closely occurring timecodes, the comments can be serially shown based on the timecodes, selectively shown based on the comment relevancy to the viewing user, or rendered in any other suitable manner. The presentation duration of each comment can be predetermined, determined based on the number of comments in close time proximity, or otherwise determined.

Displaying the comments can additionally include facilitating user interaction with the comment. User interactions can include selecting a comment, filtering the comments (e.g., excluding a first comment and presenting a second comment), replying to a comment, flagging the comment, editing the comment (e.g., a first user editing a comment posted by a first user or a first user editing a comment posted by a second user), turning the comments on or off, translating the comment, sharing the comment (e.g., on a second social networking system, etc., wherein a link to the media can additionally be embedded in association with the shared comment) or interacting with the comment in any other suitable manner. The user interactions can be tracked for the media as a whole, for each user, for each comment, or tracked in any other suitable manner.

Displaying the comment concurrently with the media at the timecode can additionally include filtering the comments. While all comments associated with the media for the timecode can be concurrently displayed with the media frame, the comments can be filtered to reduce the number of comments displayed concurrently and/or throughout media playback. The comments are preferably filtered at the user device, but can alternatively be filtered at the remote computing system. The comments can be filtered to only render new comments (e.g., comments posted since the last time the user streamed the media, comments generated after a predetermined timestamp, etc.), relevant comments, or any other suitable comment. Relevant comments can be comments generated by user accounts associated with the viewing user, comments having content with a match score above a predetermined threshold with the viewing user account or preferences, comments having a popularity score (e.g., based on the number of views of the comment, duration of each view, number of replies to the comment, number of positive votes, etc.), comments in the language of the viewing user (e.g., as determined from the language of the subtitles, language of the audio track, language indicated in the viewing user account, primary language of the geographic region of the viewing user device, etc.), comments generated from the geographic region of the viewing user device, or determined in any other suitable manner. User accounts associated with the viewing user can be user accounts directly or indirectly connected to the viewing user account through a social networking system, user accounts associated with the viewing user account through stored connections on the viewing user account, user accounts that generated comments that the viewing user has explicitly selected more than a threshold number of times or viewed for more than a threshold period of time, or be any other suitable user account.

Filtering the comments can additionally include filtering for comment content. In one variation, the comments can be filtered for spoilers (e.g., descriptions or references to media content associated with a subsequent timecode), such that only non-spoiler comments are displayed. The spoiler filter can be selectively turned on or off, or can be a default setting. Comments containing spoilers can be indicated by a second user or automatically determined based on content analysis. In one example, a first user posts a comment on a first piece of media, a second user marks the comment as spoiler, the spoiler flag is saved in association with the comment, the comment is not streamed or displayed to a third user that selected to filter out spoilers, and the comment is streamed or displayed to a fourth user that did not select to filter out spoilers.

Flagging the comments preferably includes receiving a flag or marker from a first user in association with a comment posted by a second user. The flag or marker can be stored in association with the comment by the remote computing system, and/or can be stored in association with the user account of the first user. The flag or marker can be used to filter the comment from those streamed or rendered concurrently with the media. In one example, comments having over a threshold number of flags of a given type (e.g., spoilers or vulgar) can be automatically excluded. In another example, only comments or comments from commenters associated with a flag of a second type (e.g., favorited flag) can be rendered with the media.

The method can additionally include analyzing the comments S500, which functions to analyze comment parameters of the set of comments associated with a media duration. Analyzing the comments can additionally function to identify timecodes of interest, and subsequently function to identify media frames associated with the timecodes of interest. Media parameters can subsequently be analyzed for the identified media frames. An action, such as an advertisement selection, media recommendation, secondary media generation, or any other suitable action, can subsequently be performed based on the extracted parameter values. Analyzing the comments preferably includes extracting comment parameters. Analyzing the comments can additionally include extracting media parameters.

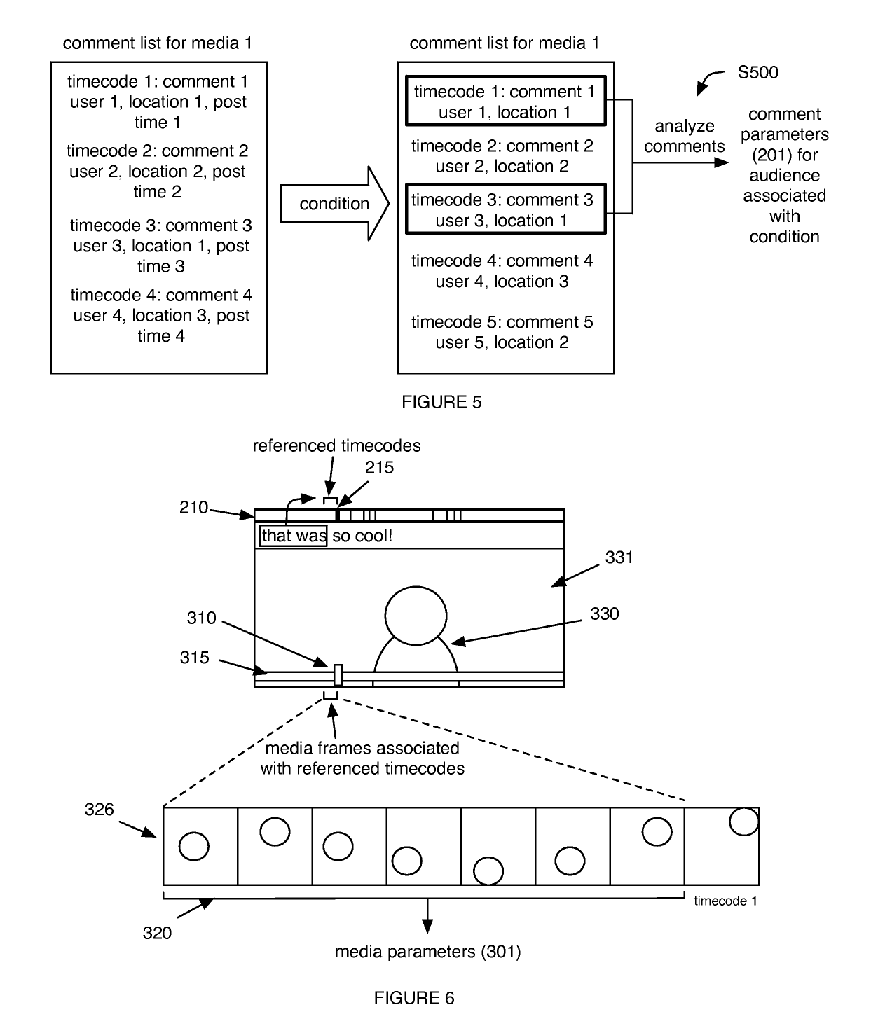

Analyzing the comment parameters of the comments associated with a media duration functions to determine a comment parameter value for the media duration S510. The comment parameter value can subsequently used to select an action (e.g., used directly to select an advertisement). The comment parameter value can additionally or alternatively be subsequently used to identify media durations of interest, which can subsequently be used to select the action. The comment parameter can be analyzed in general (e.g., across a plurality of user accounts), for a subset of users (e.g., for a plurality of user accounts satisfying a given condition), for a single user, for a subset of comments satisfying a condition (e.g., as shown in FIG. 5), or for any other suitable set of comments or users. The comment parameters can include the comment number, frequency, density, change in frequency of comments over global time, change in frequency of comments over media progression, comment type (e.g., text, image, URL, audio, etc.), comment content (e.g., sentiment, subject, association with the media, association with a secondary source), comment author parameters (e.g., number of user account connections associated with the commenter user account, number of comments posted by the commenter user account, comment author language, geographic location, age, etc.), comment viewer parameters (e.g., number of unique viewer user accounts viewing the comment, number of comment views, demographics of the viewer accounts, duration of each view, number of explicit comment selections, etc.), or any other suitable comment parameter. The comment parameter values are preferably automatically determined, but can alternatively be determined in any other suitable manner. In one example, the sentiment of the comment can be analyzed using sentiment analysis methods, such as natural language processing, text analysis, machine learning (e.g., using latent semantic analysis, support vector machines, “bag of words,” semantic orientation, etc.), statistics, or any other suitable method. The sentiment can be determined using a scaling system, wherein words can be associated with a weight (e.g., between 10 and −10) based on the associated negative, neutral, or positive sentiment, and the comment given a weight based on natural language processing methods. Alternatively, the sentiment can be determined using subjectivity/objectivity identification, feature/aspect based sentiment analysis, or any other suitable sentiment analysis method. In another example, the average or mean viewing duration for each comment in general or for a given user can be determined through eye-tracking methods, the duration of the comment presentation, or determined in any other suitable manner.

The comments can be individually analyzed, analyzed as a group, or analyzed in any other suitable set. When the comments are analyzed as a group, extracting the comment parameters can additionally include selecting a first media duration for comment analysis. The media duration can be the entire piece of media, a media segment, a media scene, a media clip, a media frame, or any other suitable media duration. The media duration can be selected based on the time that the subsequent action is to occur. The media duration can encapsulate the action (e.g., be immediately before and after the action), be contiguous with the action (e.g., be serially before or after the action), be associated with the same media as the action (e.g., be a media segment or frame discontinuous or not contiguous with the action, within the same piece of media), be associated with a different piece of media from the action (e.g., be a different episode, movie from the same actor or director, etc.), or be any other suitable media duration. The media duration for which the comments are analyzed is preferably predetermined, but can alternatively be dynamically determined based on the comment parameters. For example, the comments for the entirety of a first piece of media can be analyzed in response to the total number of comments falling below a first threshold number, while the comments for a segment of a second piece of media can be analyzed in response to the total number of comments for the segment exceeding the threshold number. The media duration can alternatively be selected based on the global comment frequency (e.g., based on the number of new comments being generated), the media comment frequency (e.g., based on the number of comments for a given media duration), or selected in any other suitable manner. The comments of the media can be analyzed for a plurality of users, wherein a first action is taken for the plurality of users, or can be analyzed for a single user, wherein a first action can be taken for a first user and a second action different from the first action can be taken for a second user, based on the same comments.

Alternatively, the set of comments (e.g., single comment or plurality of comments) can satisfy a first condition, wherein the comments associated with the media are filtered by the condition. The condition can be a demographic variable, such as age, gender, location, interest, or any other suitable demographic variable, a comment variable, such as comment type, or any other suitable condition. However, the comments for analysis can be otherwise selected.

Analyzing the comments can additionally include analyzing media parameters based on the comments associated with the piece of media. Analyzing media parameters based on the comments preferably includes identifying comments of interest, identifying media durations associated with the comments of interest S520, and extracting values for a set of media parameters from the identified media durations S530. The media parameter values can subsequently be used to select the type of action to be taken.

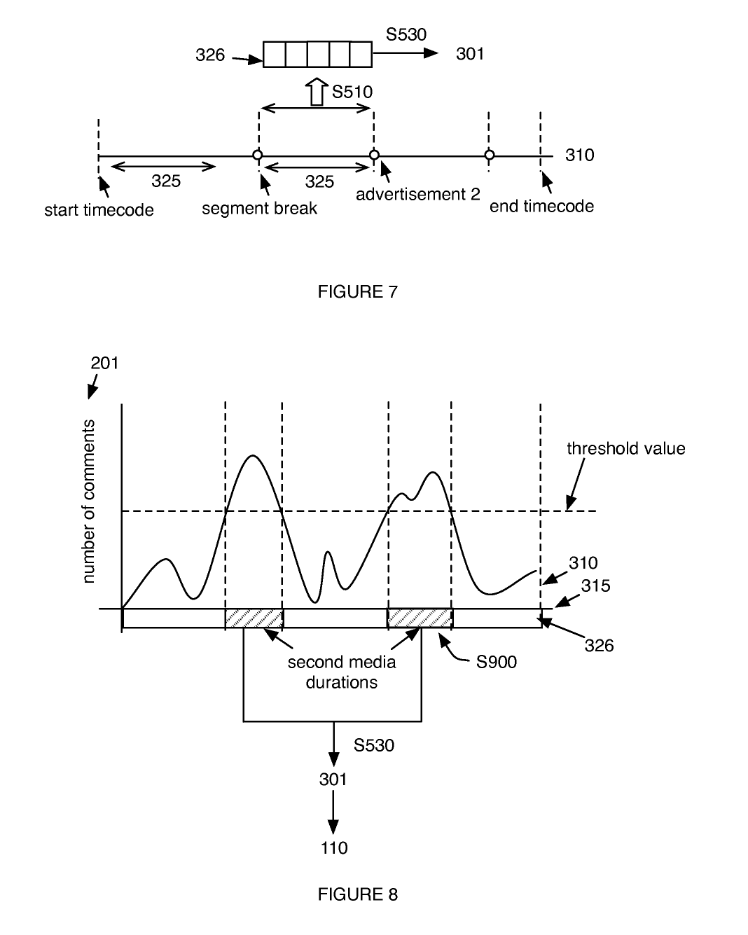

Identifying comments of interest can include identifying comments associated with a first media duration (an example of which is shown in FIG. 7), identifying comments or timecodes having comment parameter values above a threshold value, or identifying the comments in any other suitable manner. Identifying the comments associated with a first media duration can include determining the timecodes associated with the media duration and determining the comments associated with the timecodes and the media. Alternatively, identifying the comments associated with a specific media duration can include determining the audio or video frames associated with the media duration and determining the comments associated with the media audio or video frames. Alternatively, the comments associated with a specific media duration can be otherwise determined. Identifying the comments having comment parameter values above a threshold value can include determining the comment parameter value for each of the comments and filtering the comments with the threshold value, wherein the identified comments have parameter values beyond (e.g., above or below) a threshold value or range. For example, the set of comments having comment post frequencies higher than a threshold frequency can be identified. In another example, the set of comments having positive sentiments regarding a subject 330 of the media (e.g., an actor, component of the background 331 or setting, etc.) can be identified (e.g., based on the weight or strength of the association between the comment content and subjects of the respective media).

Identifying a second media duration associated with the comments of interest S900 can include identifying the second media duration based on the timecodes associated with the identified comments, identifying the second media duration based on the media frames associated with the identified comments, identifying the second media duration based on the content of the comments, or identifying the second media duration in any other suitable manner. The second media duration preferably includes a set of media frames, but can alternatively include a scene identifier, a segment identifier, or any other suitable media duration identifier. The second media duration is preferably a subset of the first media duration, and encompasses less frames than the first media duration, but can alternatively encompass the same number of frames as the first media duration. The media duration can be audio durations, video durations, or both. The second media duration can be a set of contiguous frames, a set of discontinuous frames, or any other suitable set of frames.

Identifying a second media duration based on the set of timecodes associated with the set of identified comments preferably includes extracting the set of comment timecodes (e.g., single or multiple timecodes) associated with each identified comment and determining the set of media frames associated with (e.g., encoded with) each set of comment timecodes. Alternatively, the set of media frames can be determined based on the comment timecodes. In one variation, a media segment or scene encapsulating one, all, or any other suitable subset of the media frames associated with the comment timecodes can be identified as the second media duration. In another variation, the second media duration can be defined based on the comment timecode. For example, the second media duration include a number of frames (e.g., 20 frames) before, after, or before and after the comment timecode, wherein the number of frames can be predetermined, vary according to comment parameters (e.g., the number of comments for a given timecode, the comment sentiment, etc.), or be otherwise determined.

The second media duration can alternatively be based on the media frames associated with the identified comments. This can be desirable if the comments are not associated with media timecodes, but rather associated with media frames. The second media duration can be the frames associated with the identified comments, the segments, scenes, or clips including the associated frames, or any other suitable media duration.

The second media duration can alternatively be determined based on the comment content. In one variation, a reference to a media duration (e.g., frame, scene, segment, etc.) is identified in the comment content, wherein the referenced media duration can be selected as the second media duration, an example of which is shown in FIG. 6. The referenced media duration can be determined based on temporal identifiers in the comment content, such as “that,” “that last,” “the next,” or any other suitable temporal identifier. The referenced media duration can additionally or alternatively be identified based on the subject of the media duration. For example, a scene including an actor that was referenced in the comment can be selected as the second media duration. The length of the second media duration can additionally or alternatively be determined from the comment content. For example, the scene preceding a comment stating, “That scene was so sad!” can be identified as the second media duration. In another example, the segment preceding a comment stating “I love that song” can be identified as the media duration. However, the second media duration can be otherwise determined.

Extracting media parameter values for a set of media parameters from the identified media durations S530 functions to extract media characteristics to target in subsequent actions. Media parameters can be determined for a media frame, scene, segment, clip, or any other suitable media duration. The media parameters can include audio parameters and/or video parameters. Audio parameters can include a song artist, the song genre, the audio bandwidth, BPM, tenor, average spectrum, spectral flatness, prominent tones, average zero crossing rate, popularity (e.g., based on the number, frequency or any other suitable parameter of comments associated with or referencing the audio), or any other suitable audio parameter. Video parameters can include the color or tone of the video duration, the subject of the video duration, the background of the video duration (e.g., location of the background, etc.), items appearing in the video duration, or any other suitable video parameters. Other media parameters can include the media release date, director, genre, total media length, media release platform (e.g., web release, theater release, etc.), or any other suitable media parameter.

The media parameters can be extracted from the metadata associated with the media duration of interest. The media duration of interest can be the entire piece of media, the first media duration, the second media duration, the frames of the second media duration, or any other suitable portion of the media. The media parameters can alternatively be automatically extracted based on analysis of the media frames of the second media duration. For example, audio parameter values can be determined by fingerprinting the relevant audio clip, matching the audio fingerprint with known audio information stored on a remote computing system, and retrieving the audio parameter values based on the known audio information. In another example, video parameter values can be determined based on image analysis of each frame (e.g., using object recognition, image segmentation, motion detection, video tracking, optical flow, 3D pose estimation, etc.), or any other suitable method.

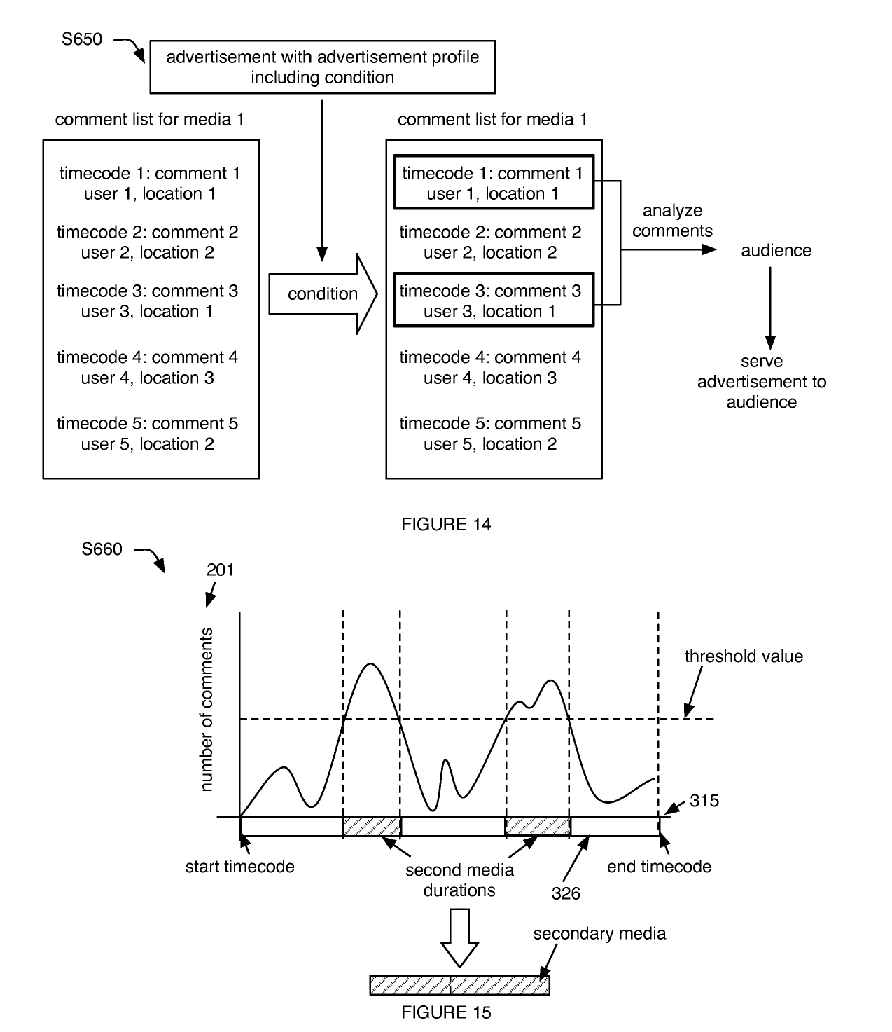

The method can additionally include performing an action based on the comment parameter values S600. The action is preferably performed based on the comment parameter values, but can alternatively or additionally be performed based on the media parameter values S601. In one variation, action performance based on the comment parameter values can additionally include performing the action based on the media parameter values, particularly when the media parameters are extracted from a media duration selected based on the comment parameter values. The action can include selecting an advertisement S610, identifying an audience for an advertisement S650 (an example of which is shown in FIG. 14), selecting a second piece of media to recommend to the user, generating secondary media S660, adding to or editing the subtitles associated with the media, sending a notification (e.g., to an advertiser or media provider), segmenting the media (e.g., based on timecodes having a local maximum or minimum number of comments, etc.), or any other suitable action.

Selecting an advertisement based on the comment parameter values S610 can include determining the advertisement S620 and presenting the advertisement S630. The advertisement can be selected for the general audience of a piece of media, wherein the advertisement is shown to a plurality of users; selected for a subset of the media audience (e.g., selected for a geographic location, specific demographic, etc.), wherein a first advertisement is shown to a member of a first audience of the media and a second advertisement different from the first is shown to a member of a second audience based on the respective audience profiles no generated for the first and second audiences; or selected for a user with respect to the piece of media, wherein a first advertisement is shown to a first user and a second advertisement different from the first is shown to a second user for the same piece of media, based on the respective audience profiles generated for the first and second audiences. However, the advertisement can be selected for any other suitable audience. The user can be known (e.g., be associated with a stored user profile), or unknown. The advertisement can be a static image, a video, an audio track, a text advertisement, or have any other suitable form factor. The advertisement preferably matches the form factor of the comments, but can alternatively match the form factor of the media, or have a different form factor from that of the media or comments.

The advertisement 400 is preferably selected for the media that is associated with the comments or the media from which the media duration for which the comment or media parameters were extracted, but can alternatively be selected for a second piece of media. The advertisement can be selected for a first media duration, wherein the first media duration includes a subset (e.g., fewer) media frames than the entire piece of media, or can be selected for the entirety of the media. More preferably, the advertisement is determined based on the comment and/or media parameter values associated with the first media duration. The first media duration can be a predetermined media duration, such as a media segment, scene, or predetermined number of timecodes, but can alternatively be a dynamically determined media duration or any other suitable media duration. The first media duration can be a media duration immediately prior to an advertisement play position in the media timeline, a media duration immediately after an advertisement play position, a media duration encompassing the advertisement play position, a media duration within the same piece of media but discontinuous with the advertisement play position (e.g., before or after the advertisement play position), or any other suitable media duration. However, the advertisement can be determined for any other suitable set of media frames. For example, the advertisements can be presented at the segment breaks between predefined media segments, wherein each advertisement can be selected based on the comments associated with the media segment before, after, or before and after the respective segment break.

Determining an advertisement based on the comment parameter functions to select an advertisement that is relevant to the audience viewing the media. Determining the advertisement can include determining an audience profile S611 and receiving the advertisement based on the audience profile S612. However, the advertisement can be otherwise determined based on the comments. The advertisement can be automatically determined prior to media streaming, a predetermined period of time (e.g., predetermined number of timecodes) before an advertisement timecode, in response to receipt of an advertisement request from a user device, or in response to the occurrence any other suitable event.

Determining an audience profile S611 functions to determine descriptors for a set of users viewing the media. The audience profile preferably includes a set of audience descriptors, such as demographic information, subject interests, or any other suitable descriptor, but can alternatively or additionally include a set of media or comment descriptors, such as a comment or media parameter value. The audience profile can be determined for a plurality of users, such as all users viewing the media or a set of users satisfying an audience condition, or generated for a single user. The subsequently determined advertisement is preferably served (e.g., sent) to the set of users for which the audience profile is generated, but can alternatively be sent to users outside of the set or a subset of the set of users. The audience profile can be determined for a media duration, wherein a first media duration can be the entire piece of media, a subset of media timecodes (e.g., less than all timecodes associated with the media), or a single media timecode. The media duration is preferably the first media duration, but can alternatively be the second media duration or be any other suitable media duration. Alternatively or additionally, the audience profile can be determined for a set of comments associated with the media, such as a set of comments satisfying a condition. The condition can be a location condition (e.g., geographic location), time condition (e.g., wherein comments posted after a predetermined timestamp can be analyzed), a timecode condition (e.g., wherein comment associated with a given set of media timecodes can be analyzed), an interaction condition (e.g., wherein comments with which users have explicitly selected, favorited, or otherwise interacted with over a predetermined frequency or number of times are analyzed), or any other suitable condition.

The audience profile can be determined based on the comment parameter values derived from the comments associated with the media duration, the media parameter values derived from media frames associated with the media duration, a combination of the comment and media parameter values, or based on any other suitable measure of audience interest in a given set of media frames, subject of the media, event associated with the media, or any other suitable media-related interest. The audience profile can be determined from the comment content, the media content, third party content referenced by the comment content, third party content referenced by the media content, user profiles associated with user accounts (e.g., commenter accounts or viewer accounts), or determined from any other suitable data source. The data source from which the audience profile is to be generated is preferably determined based on the comment and/or media parameter values, but can alternatively be determined in any other suitable manner.

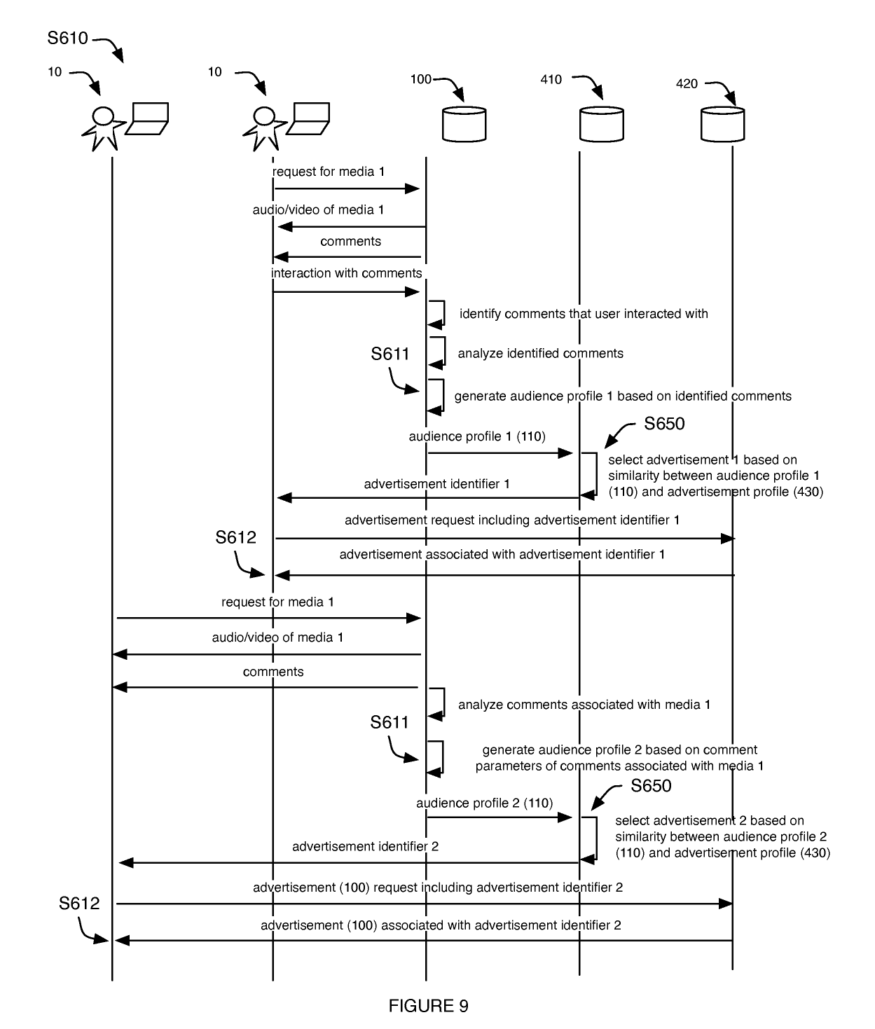

In a first example, an example of which is shown in FIG. 9, the audience profile is generated based on the user interactions with the set of comments associated with the media duration. In this example, the comment parameter analyzed for the set of comments preferably includes the number of interactions or the frequency of interactions with each comment, but can alternatively include any other suitable comment parameter. The comments having a comment parameter value above a threshold value are preferably identified. The contents of the identified comments can be analyzed to extract references to the media, to third party media, or any other suitable reference, wherein the audience profile is generated from the reference. Alternatively, the media frames associated with the identified comment can be analyzed to extract media parameters, such as the subject of the video or audio track artist, wherein the audience profile can include the media parameters. Alternatively, the audience profile can be generated based on the commenter account, wherein the variable values of the commenter account can be included in the audience profile or otherwise influence audience profile generation. Alternatively, the audience profile can be generated based on the user account(s) that interacted with the identified comments.

Alternatively or additionally, the audience profile can be generated based on the set of user accounts that have interacted with at least one of the set of comments associated with the media duration. The set of user accounts can include all user accounts, user accounts satisfying a condition (e.g., a location condition, demographic condition, historical condition, etc.), users currently viewing the media (e.g., currently viewing media frames having timecodes prior to the time at which the advertisement is to be shown), or include any other suitable user. The interactions are preferably historical interactions, but can additionally or alternatively be substantially instantaneous interactions.

In a second example, an example of which is shown in FIG. 9, the audience profile can be determined based on the content of the comments associated with the first media duration and/or the content of the media frames associated with the comment timecodes. For example, the audience profile can indicate an interest in an actress when the frequency of references to an actress in comments associated with the media exceeds a threshold frequency.

In a third example, the audience profile can be generated based on the user profiles associated with user accounts posting comments (commenter accounts) to the media duration. For example, the average or most common profile variable values shared amongst the commenter accounts can be aggregated into the audience profile.

In a fourth example, the audience profile can be determined based on the user profiles associated with user accounts viewing comments (viewer accounts) on the media. For example, the average or most common profile variable values shared amongst the viewer accounts can be aggregated into the audience profile.

In a fifth example, as shown in FIG. 8, the audience profile can be determined based on the media parameter values of the second media duration (e.g., wherein the second media duration can function as the highlights or popular points of the media), as determined based on the associated comment parameter values. The second media duration can be determined based on the number or frequency of the comments associated with (e.g., sharing a timecode with or referencing) the media duration. However, the second media duration can be determined in any other suitable manner. The audience profile can include the media parameter values or an abstraction thereof of the second media duration.

In a sixth example, the audience profile can be determined based on the most recently posted comments for a piece of media. The audience profile can be determined from the profile associated with the commenter account, from the media parameters of the media duration associated with the comment, from the comment content, or from any other suitable source.

In a seventh example, the audience profile can be determined for a given user based on the profile of commenter accounts that posted the comments explicitly selected by a user. Alternatively, the audience profile for a given user can be determined based on the viewer accounts that also viewed or interacted with the comments explicitly selected by the user.

In an eighth example, the audience profile can be determined for a given user based on the comments posted by the user. The audience profile can be determined based on the comment content, the media parameters of the media frames associated with the user-posted comment (e.g., the video subject, audio track, etc.), the user profiles of user accounts that viewed the comment, or determined in any other suitable manner.

In a ninth example, the audience profile can be determined for a given user based on the comment interactions and/or comments posted by secondary user accounts that are associated with the user account of the user (e.g., connected to the user account within a social networking system, etc,). The audience profile can be generated based on the comment parameters (e.g., comment content), the media parameters of the media associated with the comments, the user profiles of the secondary user accounts, or determined in any other suitable manner.

In a tenth example, the audience profile can be determined for a given user based on known parameters of the user. The user can be a known user with a user account, wherein the audience profile can be generated based on the user profile associated with the user account, or can be an unknown user. The audience profile can include and/or be generated based on the location of the user, the user device identifier, or any other suitable information. The user information can be determined from the user connection, from metadata included in a media request, or determined in any other suitable manner.

Receiving the advertisement based on the audience profile S612, an example of which is shown in FIG. 9, functions to receive the advertisement to be presented to the user. The advertisement is preferably received from a remote computing system of a third-party advertiser 420, but can alternatively be received from any other suitable source. The advertisement is preferably received by the remote computing system, but can additionally or alternatively be received by the user device. In the latter case, the remote computing system can stream the advertisement to the user device or send an advertisement identifier to the user device, wherein the user device requests and receives the advertisement from a third-party advertiser. However, the advertisement can be otherwise sent to the user device.

In a first variation, receiving the advertisement includes selecting an advertisement from an advertisement database 410 based on the audience profile. Selecting an advertisement preferably includes determining an advertisement similarity score for an audience profile and selecting the advertisement associated with the highest similarity score. The advertisement similarity score is preferably determined based on the similarity between the audience profile and the content of the advertisement (e.g., the audio track of the advertisement, the subject of the advertisement, etc.), but can alternatively be determined based on the similarity between the audience profile and an advertisement profile 430 (e.g., a description of the user parameters, comment parameters, or media parameters that an advertiser would like to target with the advertisement), or be determined in any other suitable manner. The similarity score is preferably calculated, but can be otherwise determined. In one example, the audience profile includes a subject of the media, such as an actor. The advertisement selected based on the audience profile preferably features a first actor, but can alternatively feature a second actor different from the first that appeals to a similar demographic as the first actor.

In a second variation, receiving the advertisement includes sending the audience profile to an advertisement exchange, receiving an advertisement identifier from the advertisement exchange, wherein the bidding process on the advertisement exchange selects the advertisement to be shown in association with the media, requesting the advertisement from the advertiser, and receiving the advertisement. The audience profile is preferably generated from the comment parameter values and/or media parameter values, but can alternatively be unprocessed comment parameter values and/or media parameter values, or be generated in any other suitable manner. The audience profile can include a composite profile generated based on the user accounts of the commenters (e.g., of the first media duration), a composite profile generated from the user accounts of the comment viewers (e.g., of the first media duration), a subject (e.g., identity of a person or object, etc.) extracted from the media (e.g., from the second media duration), an audio track extracted from the media (e.g., of the second media duration), the comment frequency for the media duration, the number of comments for the media duration, any other suitable comment or media parameter value for the media duration, or any other suitable advertisement parameter value. The audience profile can additionally or alternatively include a user summary of the user to which the advertisement is to be shown, wherein the user summary can be determined from a user profile associated with a user account viewing the media, the profiles of the commenters posting the comments that the user (known or unknown) has interacted with in a given set of sessions (e.g., one or multiple viewing sessions), the information received based on the data connection used by the user (e.g., the geographic location, device information, etc.), or include any other suitable information about the viewer. However, the audience profile for the advertisement exchange can be otherwise generated.

Presenting the advertisement S630 functions to render the selected advertisement in association with the media. The advertisement is preferably presented proximal the media, but can alternatively be presented distal the media. The advertisement is preferably presented proximal the media temporally, but can alternatively be presented proximal the media spatially. Presenting the advertisement temporally proximal the media can include serially presenting the advertisement (e.g., contiguously presented) with a duration of the media, wherein media playback can be paused prior to advertisement presentation and resumed after advertisement presentation. The media duration can be the first media duration that was analyzed to generate the audience profile, or can be a second media duration including different timecodes from the first media duration. The second media duration can include a subset of the first media duration, the entirety of the first media duration, or be entirely separate from the first media duration. Alternatively or additionally, presenting the advertisement temporally proximal the media can include concurrently presenting the advertisement with the media, discontinuously presenting the advertisement from the media (e.g., presenting the advertisement with a second piece of media), or presenting the advertisement temporally proximal the media in any other suitable manner. Presenting the advertisement spatially proximal the media can include presenting the advertisement in a virtual space adjacent the media player playing the media (e.g., a skin surrounding the media player, a window adjacent the media player, etc.), presenting the advertisement within the media player (e.g., within the comment box or window 220 as a comment or a comment box background, in a second window overlaid or embedded within the media player, in the media player, etc.), or otherwise arranging the advertisement.

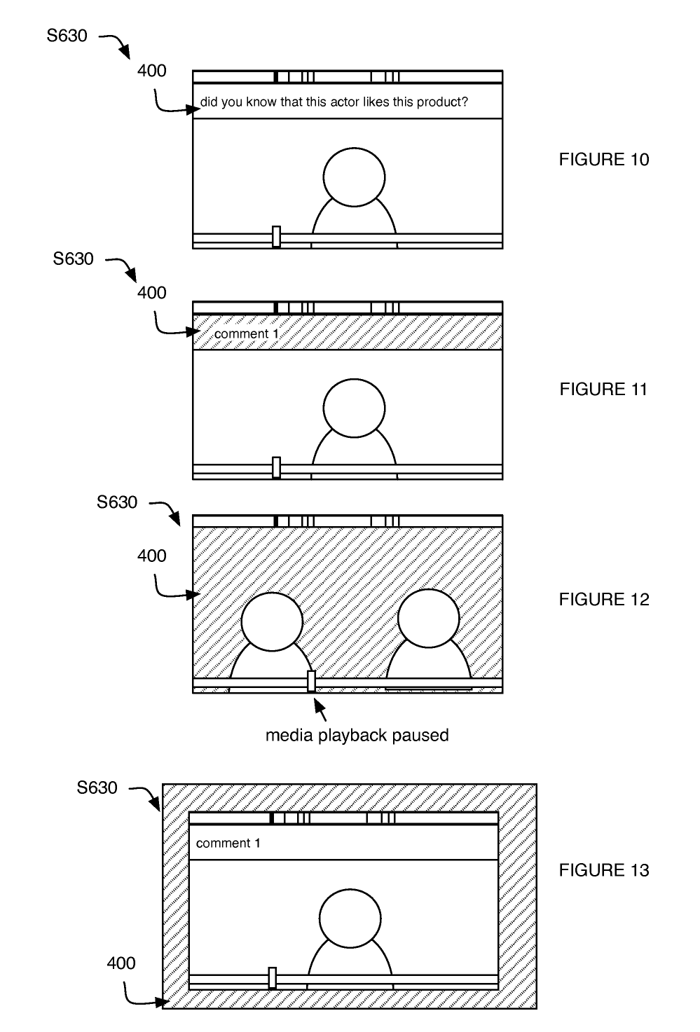

In one variation of presenting the advertisement, the advertisement is played in series with a media duration (e.g., media segment), wherein media playback is paused during advertisement presentation, as shown in FIG. 12. The media duration can be the first media duration (e.g., the media duration for which comment parameters were analyzed) or a different media duration. In a second variation of presenting the advertisement, the advertisement is presented concurrently with the media, either outside the media player (as shown in FIG. 13), or overlaid over a portion of the media, within the media player (as shown in FIGS. 10 to 12). However, advertisements can be otherwise presented relative to media playback at the remote user device.

The method can additionally include providing the advertiser with a measure of user exposure to the advertisement. The measure of user exposure to the advertisement can be the number of comments received from users during advertisement display, the number of user interactions (e.g., shares, likes, etc.) with the advertisement, or any other suitable measure of user interaction in association with the advertisement.

Performing an action based on the comments can additionally include automatically generating secondary media based on the first piece of media S660, an example of which is shown in FIG. 15. The second piece of media preferably includes the highlights of the first piece of media, but can additionally or alternatively include any other suitable media. The highlights of the first piece of media are preferably media segments or clips associated with a content parameter value, such as a comment density, higher than a threshold value. One example of the method includes analyzing the comments of the first media for the comment parameter, identifying a set of media timecodes associated with comment parameters greater than the threshold value, identifying the media durations associated with the set of media timecodes, and aggregating the media durations into the second media. The media duration identified for inclusion into the second media are preferably media segments (e.g., those defined using the method disclosed in U.S. application Ser. No. 13/970,034 filed 19-Aug.-2013, incorporated herein in its entirety), but can alternatively be media clips, a predetermined number of media frames defined from each of the set of media timecodes, or any other suitable media duration. The analyzed comments can additionally be pre-filtered with a condition, such that only comments satisfying the condition are analyzed. The condition can be a location condition (e.g., a geographic limitation), a demographic condition (e.g., an age or gender limitation), or any other suitable condition.

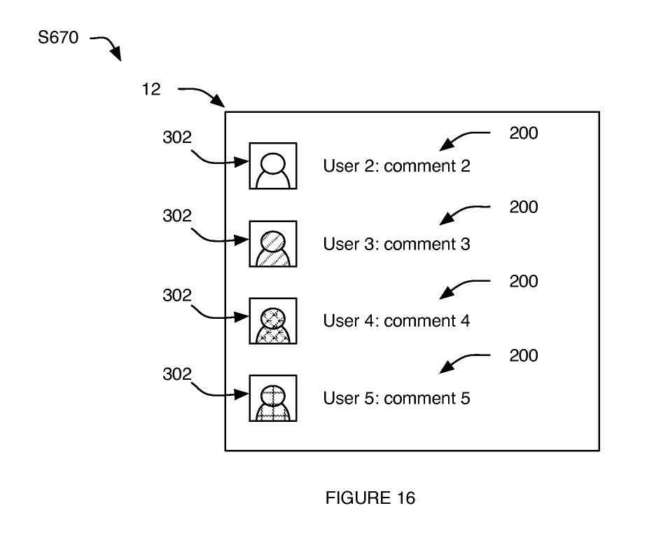

Performing an action based on the comments can additionally include facilitating user discovery S670. In one variation of the method, a first user account can be connected to a set of secondary user accounts. Timecoded comments 200 posted by the secondary user accounts to media are preferably listed, in near real-time or asynchronously, on a feed for the first user account. As shown in FIG. 16, the timecoded comments can be presented in the feed 12 alongside a representation of the media 302 on which the comment was posted (e.g., the media associated with the timecode of the comment), a representation of the commenter account, or alongside any other suitable information. The representation of the media can include the video frame of the media that is associated with the respective timecode of the comment, a highlighted frame of the respective media (e.g., a video frame of the media associated with a density of comments over a threshold density), a randomly selected video frame, or can be any other suitable representation of the media.

An alternative embodiment preferably implements the above methods in a computer-readable medium storing computer-readable instructions. The instructions are preferably executed by computer-executable components preferably integrated with an advertisement selection system. The advertisement selection system can include a comment receiving system that receives timecoded comments in association with media, a comment analysis system that analyzes the comment parameters of the timecoded comments, a media analysis system that analyzes the media parameters of media frames associated with the comment timecodes, an audience profile system that generates an audience profile based on the comment parameters and/or media parameters, and the advertisement selection system, which selects the advertisement based on the audience profile. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for serving an advertisement in association with media, the media including audio and video, the method comprising:
receiving a set of comments for the media, each comment associated with a media timecode;
extracting a comment parameter from the set of comments;
identifying a timecode having a comment parameter value beyond a threshold value;
identifying a media segment associated with the timecode;
extracting a media parameter from the media segment;
selecting an advertisement based on the media parameter; and
presenting the advertisement contiguously with the media.

2. The method of claim 1, wherein presenting the advertisement contiguously with the media comprises:
playing the media;
pausing media playback;
playing the advertisement; and
playing the media after advertisement playback.

3. The method of claim 1, wherein identifying a media segment comprises identifying an audio clip associated with the timecode, wherein extracting the media parameter comprises identifying an audio parameter from the audio clip, and wherein selecting the advertisement based on the media parameter comprises selecting the advertisement based on the audio parameter.

4. The method of claim 3, wherein the audio clip encompasses an audio frame assigned to the timecode.

5. The method of claim 3, wherein the audio parameter comprises an artist of the audio clip, wherein the advertisement is associated with the artist.

6. A method for serving an advertisement in association with media, the media including audio and video, the method comprising:
receiving a set of comments for a first media segment, each comment associated with a media time code;
extracting a comment parameter from the set of comments;
selecting an advertisement based on the comment parameter;
presenting the advertisement proximal the first media segment.

7. The method of claim 6, wherein presenting the advertisement proximal the first media segment comprises presenting the advertisement at a time contiguous with a segment of the media.

8. The method of claim 7, wherein presenting the advertisement at a time contiguous with a segment of the media comprises presenting the advertisement at a time contiguous with the first media segment.

9. The method of claim 8, wherein presenting the advertisement at a time contiguous with the first media segment comprises presenting the advertisement after the first media segment.

10. The method of claim 8, wherein presenting the advertisement at a time contiguous with the first media segment comprises presenting the advertisement within the first media segment

11. The method of claim 6, wherein presenting the advertisement proximal the first media segment comprises concurrently presenting the advertisement with the first media segment.

12. The method of claim 11, wherein the first media segment is presented within a media player, and the advertisement is presented within a digital area surrounding the media player.

13. The method of claim 6, wherein selecting an advertisement based on the comment parameter comprises:
identifying a timecode having a comment parameter value beyond a threshold value;
identifying a clip of the first media segment associated with the timecode;
extracting a media parameter from the clip; and
selecting the advertisement based on the media parameter.

14. The method of claim 13, wherein extracting a comment parameter from the set of comments comprises extracting the comment frequency for each media timecode associated with the first media segment, wherein the threshold value comprises a threshold comment frequency.

15. The method of claim 14, wherein identifying a clip associated with the timecode comprises identifying a video clip associated with the timecode; wherein extracting the media parameter comprises extracting a video parameter from the video clip, and wherein selecting the advertisement based on the media parameter comprises selecting the advertisement based on the video parameter.

16. The method of claim 15, wherein the video parameter comprises a subject of the video clip, wherein the advertisement is associated with the subject.

17. The method of claim 6, further comprising:
playing the media at a user device;
concurrently displaying the comments at the respective timecodes, with the media, at the user device;
receiving a comment selection from the user device, the comment associated with a first timecode; and
playing the media from a media frame associated with the first timecode.

18. The method of claim 17, further comprising:
tracking selected comments for the user;
tracking a comment view duration for the user;
wherein extracting the comment parameter comprises:
identifying a comment having a comment view duration for the user beyond a duration threshold;
extracting a comment parameter from the identified comment; and
selecting the advertisement based on the extracted comment parameter.

19. The method of claim 18, wherein the comment parameter comprises a timecode, wherein selecting the advertisement based on the extracted comment parameter comprises identifying a media clip associated with the timecode; and selecting an advertisement having a match value above a match threshold with the media clip.

20. The method of claim 6, wherein selecting the advertisement for the media based on the comment parameter comprises selecting a first advertisement for a first user account and selecting a second advertisement for a second user account, the second advertisement different from the first advertisement, wherein the first and second user accounts are associated with a first and second comment parameter for the media, respectively, wherein the second comment parameter is different from the first comment parameter.
